(19) United States
(12) Patent Application Publication
(10) Pub. No.: US 2018/0005766 A1
(43) Pub. Date: Jan. 4, 2018

(54) CONDUCTIVE TEXTILES AND RELATED DEVICES

(71) Applicant: Wisconsin Alumni Research Foundation, Madison, WI (US)

(72) Inventors: Marianne Fairbanks, Madison, WI (US); Trisha Andrew, Madison, WI (US)

(21) Appl. No.: 15/200,562

(22) Filed: Jul. 1, 2016

(51) Int. Cl. H01G 9/20; D04B 1/10

(52) U.S. Cl. CPC H01G 9/2095; D04B 1/102; H01G 9/2063

(57) ABSTRACT

A conductive textile is provided comprising a textile substrate comprising a network of one or more threads, each thread comprising one or more fibers, the one or more threads arranged to define a plurality of pores and a plurality of intersections distributed throughout the textile substrate, and a conductive polymer coating on a surface of the textile substrate, wherein the textile substrate is characterized by a porosity which is sufficiently high to achieve a substantially maximum conductivity for the conductive textile. The conductive textile may be incorporated into a variety of electronic devices, including solar cells.

### BACKGROUND

Integrating electronic devices into textiles is considered to be the next-generation resolution to meet the requirement of light-weight, flexibility and wearability. Smart clothes made from such functional textiles have the value of being interactive and providing sensing, power generating and energy storage capabilities. Two approaches have been applied for building electronic textiles, either integrating complete electronic devices into textiles by various techniques, such as patching, or fabricating electronic devices on textiles or fibers to realize true integration into apparel. Although most demonstrated prototypes are based on integrating conventional bulky devices into textiles, true integration is necessary to maintain natural look and feel of garments to help them gain acceptance for everyday use.

Organic materials are compatible with future electronic textiles as compared to their inorganic counterparts, due to their mechanical flexibility, morphological stability against repeated bending and folding operations, low toxicity to humans, ease of chemical synthesis and processing, and low cost. However, a challenge of all-organic materials electronics is electrical conductivity, since many organic materials are non-conductive.

### SUMMARY

Provided herein are conductive textiles and devices incorporating the conductive textiles.

In one aspect, a conductive textile is provided comprising a textile substrate comprising a network of one or more threads, each thread comprising one or more fibers, the one or more threads arranged to define a plurality of pores and a plurality of intersections distributed throughout the textile substrate, and a conductive polymer coating on a surface of the textile substrate, wherein the textile substrate is characterized by a porosity which is sufficiently high to achieve a substantially maximum conductivity for the conductive textile. The conductive textile may be incorporated into an electronic device.

In another aspect, a solar cell is provided comprising a conductive textile comprising a textile substrate comprising a network of one or more threads, each thread comprising one or more fibers, the one or more threads arranged to define a plurality of pores and a plurality of intersections distributed throughout the textile substrate, and a conductive polymer coating on a surface of the textile substrate, wherein the textile substrate is characterized by a porosity which is sufficiently high to achieve a substantially maximum conductivity for the conductive textile; an active layer on the conductive textile; and a top electrode on the active layer.

Other principal features and advantages of the invention will become apparent to those skilled in the art upon review of the following drawings, the detailed description, and the appended claims.

### BRIEF DESCRIPTION OF THE DRAWINGS

Illustrative embodiments of the invention will hereafter be described with reference to the accompanying drawings, wherein like numerals denote like elements.

FIGS. 1A-1E show cotton textiles of CV055 (FIG. 1A), WC45 (FIG. 1B), CS (FIG. 1C), CC110 (FIG. 1D) and PTC45/58 (FIG. 1E). In each figure, panel (1) shows a microscopic image of the PEDOT (poly(3,4-ethylenedioxythiopene)) coated textile, panel (2) shows the resistance measurement of a 1×1 inch² PEDOT coated textile, panels (3) and (5) show SEM images of the pristine textile before PEDOT coating, and panels (4) and (6) show SEM images of the PEDOT coated textile.

FIGS. 2A-2C show linen textiles of LIN21 (FIG. 2A), LIN (FIG. 2B) and LIN6 (FIG. 2C). In each figure, the panels shown are analogous to those of FIGS. 1A-1E.

FIGS. 3A-3B show silk textiles of HS12 (FIG. 3A) and SD (FIG. 3B). In each figure, the panels shown are analogous to those of FIGS. 1A-1E.

FIGS. 4A-4D show textiles of pineapple fiber (FIG. 4A), banana fiber (FIG. 4B), wool gauze (FIG. 4C) and bamboo rayon (FIG. 4D). In each figure, the panels shown are analogous to those of FIGS. 1A-1E.

FIG. 5 provides a summary of resistance measured on 1×1 inch² samples of the different textiles of FIGS. 1A-1E, 2A-2C, 3A-3B, and 4A-4D.

FIG. 6 shows microscopic images of threads from a textile coated with PEDOT. The textile is bamboo rayon. The top image shows a warp thread and the bottom image shows a weft thread. Darker regions indicate the presence of the PEDOT coating; lighter regions indicate the absence of the PEDOT coating.

FIG. 7 shows a plot of resistance of 1×1 inch² size textiles versus value of R₁×R₂.

FIG. 8 shows a summary of resistance values of 3 inch long threads fully coated with PEDOT.

FIG. 9 shows a schematic of a pre-woven textile substrate according to an illustrative embodiment.

FIG. 10 shows a schematic of a pre-knit textile substrate according to an illustrative embodiment.

FIG. 11 shows a schematic of an organic dye-based solar cell on a textile substrate according to an illustrative embodiment.

### DETAILED DESCRIPTION

Provided herein are conductive textiles and devices incorporating the conductive textiles. The conductive textiles disclosed herein are based, at least in part, on the inventors' discovery that simply applying a conductive coating to a non-conductive textile substrate does not necessarily provide a textile which is sufficiently conductive to provide a viable, operative device, e.g., a solar cell. Instead, the inventors have discovered that certain characteristics of the textile substrate itself (as opposed to the type of conductive coating or the method of forming the conductive coating) play a significant and previously unknown and unappreciated role on the conductivity of the coated textile.

In one aspect, a conductive textile is provided comprising a textile substrate having a surface and a conductive polymer coating on the surface. By “textile substrate” it is meant a flexible network of one or more threads arranged to define a plurality of pores, and a plurality of intersections at which different threads or different portions of a thread cross, distributed throughout the textile substrate. The thread(s) of the textile substrates are composed of one or more fibers, which may be spun together to form each thread. Individual threads may be plied together to form a yarn, in which case the term “yarn” may be used in place of “thread.” The material from which the fiber(s) are composed may be natural or synthetic. Illustrative natural materials include protein-based, animal materials such as wool and silk and cellulose-acetate-based, plant materials such as cotton, flax, bamboo, pineapple, banana, etc. Natural materials may also include mineral materials, e.g., glass. Illustrative synthetic materials include polyester, acrylic, nylon, etc. Different types of fibers may be included in the thread to form a composite thread. Similarly, different types of threads may be used in the network to form a composite textile substrate.

The textile substrate is organic in nature, i.e., the material of the fiber(s) comprises both carbon and hydrogen, although the material may comprise other elements. However, in some embodiments, the textile substrate is substantially free of metals, i.e., the fiber(s) of the textile substrate are not composed of metals. The term “substantially free” is used in recognition of the fact that during a typical manufacturing process, the textile substrate may come to include trace amounts of metal(s). Such textile substrates may still be considered to be metal-free. The textile substrate (prior to be coated with the conductive polymer) may be substantially non-conductive, by which it is meant that it is sufficiently resistant to conducting an electric current that it would be considered an insulator.

The dimensions of the fiber(s) depend upon the material from which the fiber(s) is composed. Each fiber may be characterized by a staple length, the dimension of the fiber along its longitudinal axis, and a diameter. The staple length may refer to an average value of a collection of fibers. The dimensions of the thread(s) depend upon the type of fiber and the number of fibers used to form the thread. Each thread may also be characterized by a length and a diameter. If the diameter of the thread is not uniform along its length, the diameter of the thread may refer to an average value of the diameter along the length of the thread. Threads having different diameters may be used in the network of the textile substrate.

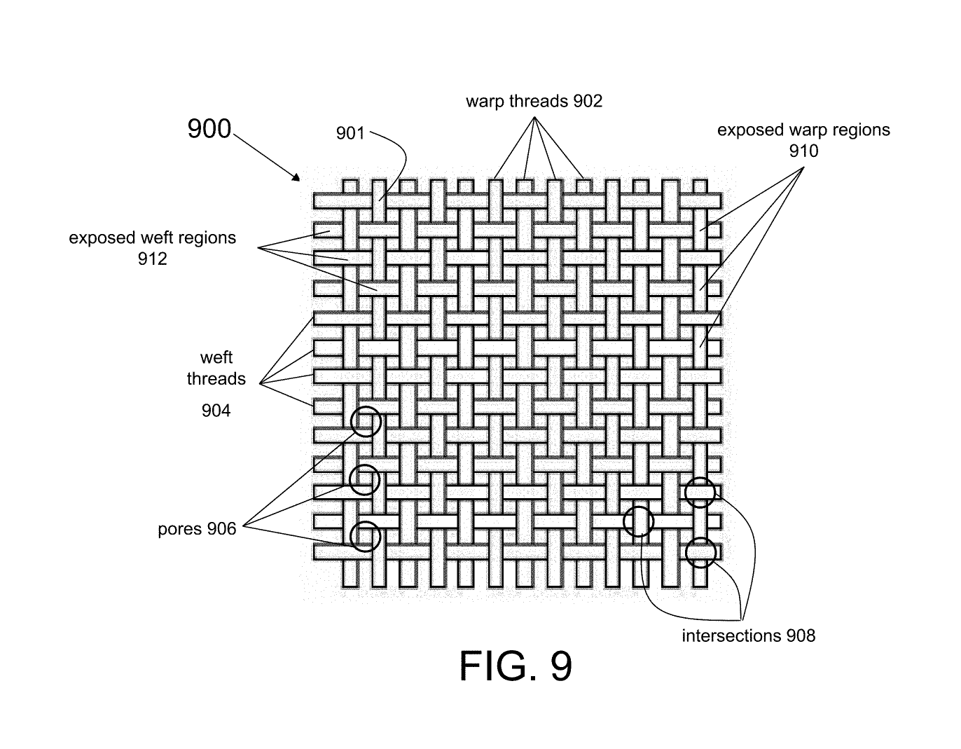

The network of thread(s) may be formed by a variety of techniques, e.g., weaving, knitting, etc. A “woven” or “pre-woven” textile substrate refers to a textile substrate in which a first plurality of threads are interlaced with a second plurality of threads, wherein the threads of the first plurality of threads are oriented approximately perpendicular to the threads of the second plurality of threads. Threads running vertically are known as “warp” threads and threads running horizontally are known as “weft” threads. A schematic of an illustrative pre-woven textile substrate 900 having an upper surface 901 is shown in FIG. 9 which comprises a plurality of warp threads (some of which are labeled 902) interlaced with a plurality of weft threads (some of which are labeled 904). (Herein, the use of directional terms such as “upper” and the like are merely intended to facilitate reference to the various surfaces of the textile substrates and are not intended to be limiting.) A pre-woven textile substrate may be characterized by its weave type, i.e., the manner in which the warp threads and the weft threads are interlaced. Various weave types may be used, e.g., plain, satin, twill, basket, etc. The pre-woven textile substrate 900 of FIG. 9 shows a plain weave.

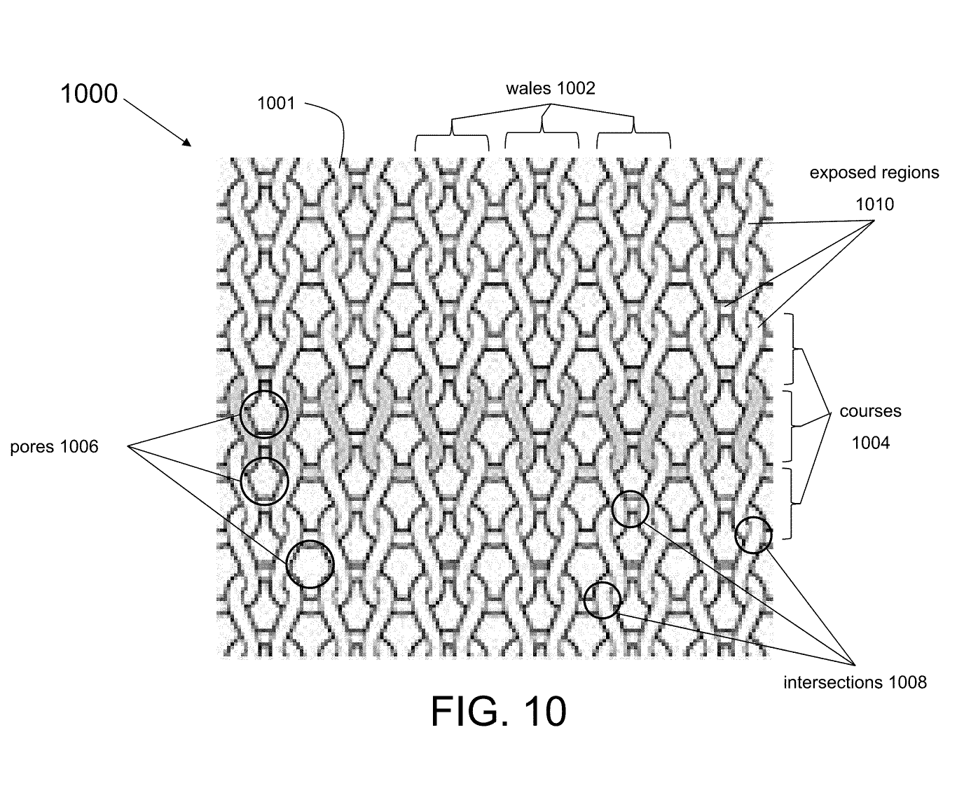

A “knit” or “pre-knit” textile substrate refers to a textile substrate in which a single thread (although more than one thread may be used) is interlooped to create rows and columns of vertically and horizontally interconnected stitches. The vertical column of stitches is known as a “wale” and the horizontal row of stitches is known as a “course.” A schematic of an illustrative pre-knit textile substrate having an upper surface 1001 is shown in FIG. 10 which comprises a single thread interlooped to provide a plurality of wales (some of which are labeled 1002) and a plurality of courses (some of which are labeled 1004). A pre-knit textile substrate may be characterized by the stitch type and combination of stitch types used. Stitch types include knit stitch, purl stitch, missed stitch and tuck stitch. The pre-knit textile substrate 1000 of FIG. 10 shows all knit stitches.

Regardless of the technique used to form the network of thread(s) of the textile substrate, as described above, those thread(s) define both a plurality of pores, e.g., void spaces, and a plurality of intersections at which different threads or different portions of a thread cross, which are distributed throughout the textile substrate. Pores 906 and intersections 908 within the pre-woven textile substrate 900 are labeled in FIG. 9. Pores 1006 and intersections 1008 within the pre-knit textile substrate 1000 are labeled in FIG. 10.

The textile substrates may be characterized by their porosity, which is the percentage of void spaces defined in the textile substrate. As the porosity of the textile substrate increases, the magnitude of the area of the upper surface available to be coated by the conductive polymer decreases. However, as described in the Examples, below, the inventors have found that as the porosity of the textile substrate increases, the conductivity of the coated textile substrate actually increases, despite the loss in surface area. Therefore, the porosity of the textile substrate may be selected to achieve a selected conductivity value (e.g., a substantially maximum value) for the conductive textile. The term “substantially maximum” is used in recognition of the fact that the value may not be at the perfect maximum, but is sufficiently near to the maximum (e.g., within ±2%, ±5%, ±10% of the maximum value). In view of the inventors' discovery of the direct correlation between porosity and conductivity and inverse correlation between surface area and conductivity, the selected porosity will typically be a value at which the surface area of the textile substrate is not maximized. In some embodiments, the porosity of the textile substrate is at least about 5%, at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%. This includes embodiments in which the porosity of the textile substrate is in the range of from about 5% to about 90%. Porosity may be determined from images (e.g., microscope or SEM images) of coated textile substrates by using software to measure the area of void spaces as compared to the total area of the textile substrate.

As discussed in the Example, below, textile substrates may be characterized by their density (having units, e.g., of ounces per square yard, oz/yd²). Density is generally inversely proportional to porosity. Therefore, the density of the textile substrate may be selected to achieve a selected conductivity value (e.g., a substantially maximum value) for the conductive textile. Again, the selected density will typically be a value at which the surface area of the textile substrate is not maximized. In some embodiments, the density of the textile substrate is no more than about 5 oz/yd², no more than about 4 oz/yd², no more than about 3 oz/yd², no more than about 2 oz/yd², or no more than about 1 oz/yd². This includes embodiments in which the porosity of the textile substrate is in the range of from about 1 oz/yd² to about 5 oz/yd². Known techniques may be used to determine the density of a textile substrate.

Achieving the porosity/density values described above may be achieved through selection of a network type (e.g., pre-woven, pre-knit, etc.), a weave type, a stitch type, and/or thread(s) diameter for the textile substrate.

The intersecting thread(s) in the textile substrates result in buried thread interfaces in which regions of the thread(s) of the textile substrates are unexposed or inaccessible, e.g., to a conductive polymer coating deposited on the upper surface of the textile substrate. For pre-woven textile substrates, each warp thread comprises a plurality of exposed regions and a plurality of unexposed regions. Similarly, each weft thread comprises a plurality of exposed regions and a plurality of unexposed regions. Some of the exposed regions 910 of the plurality of warp threads of the upper surface 901 of the pre-woven textile substrate 900 are labeled in FIG. 9. Some of the exposed regions 912 of the plurality of weft threads of the upper surface 901 of the pre-woven textile substrate 900 are also labeled in FIG. 9. Each unexposed region in the plurality of unexposed regions of the upper surface 901 is located at a respective buried thread interface, including those formed at the intersections 908.

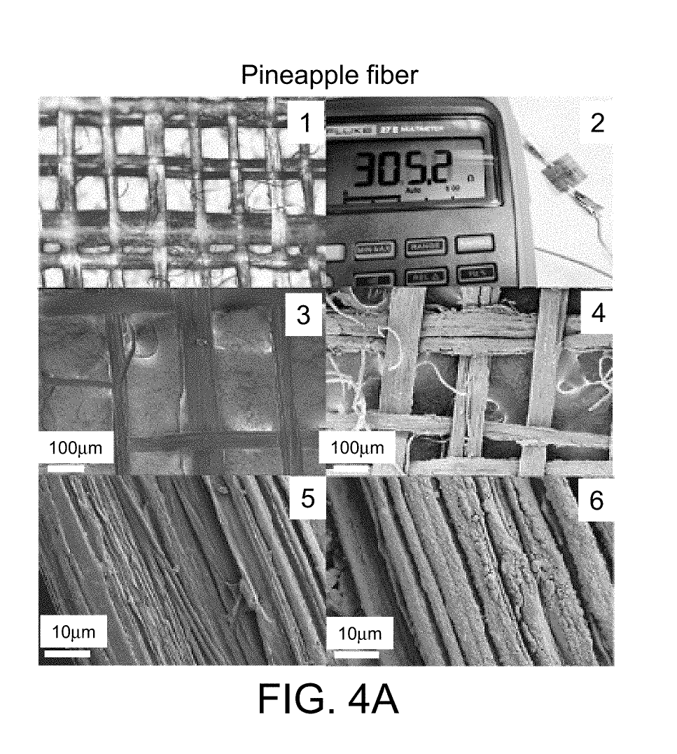

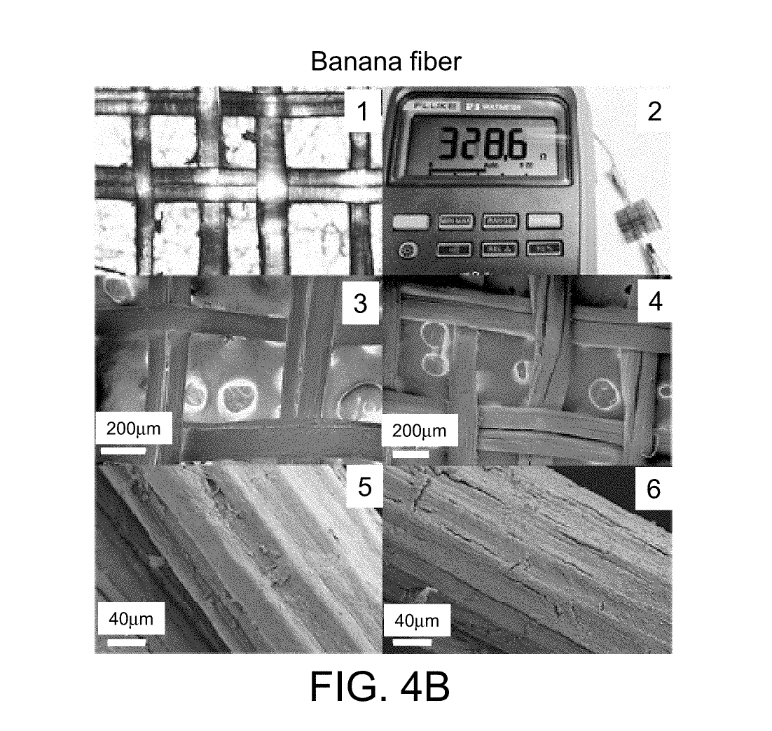

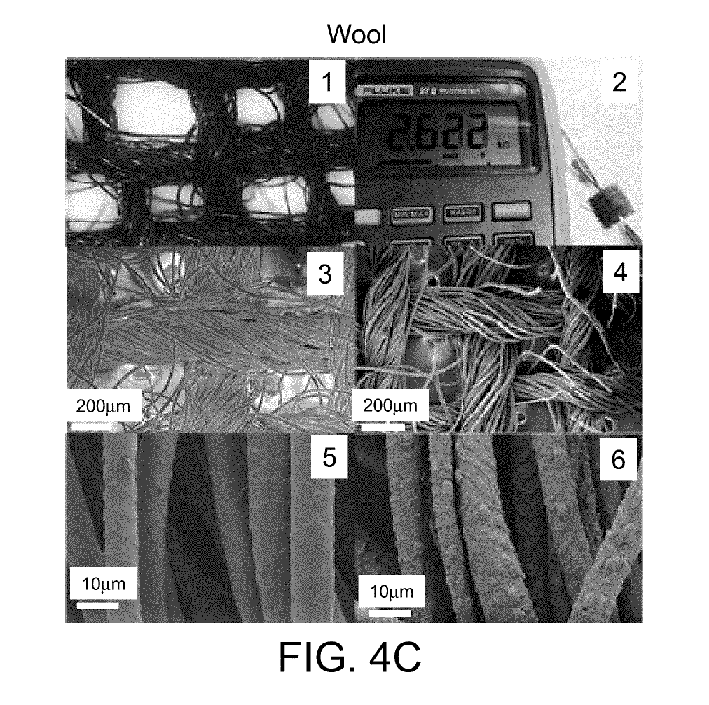

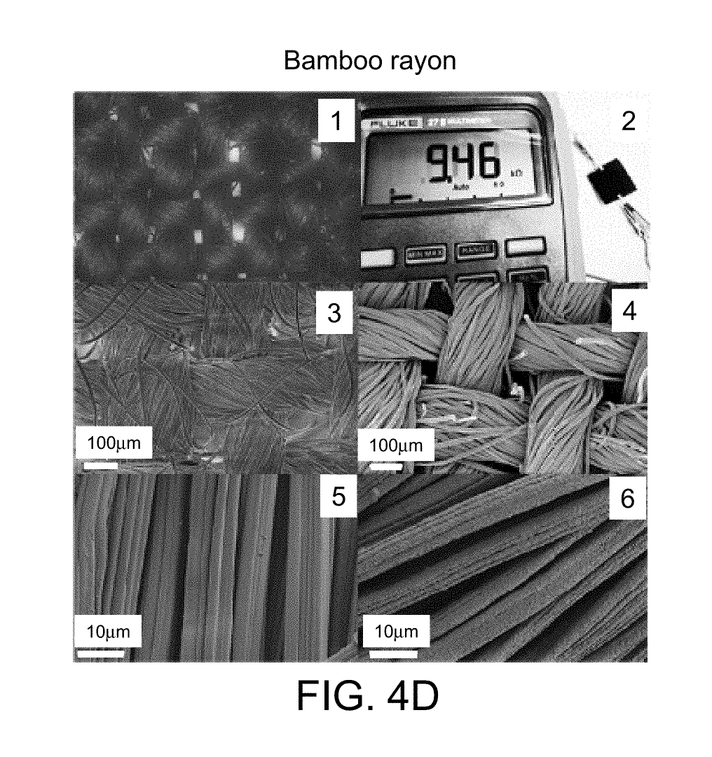

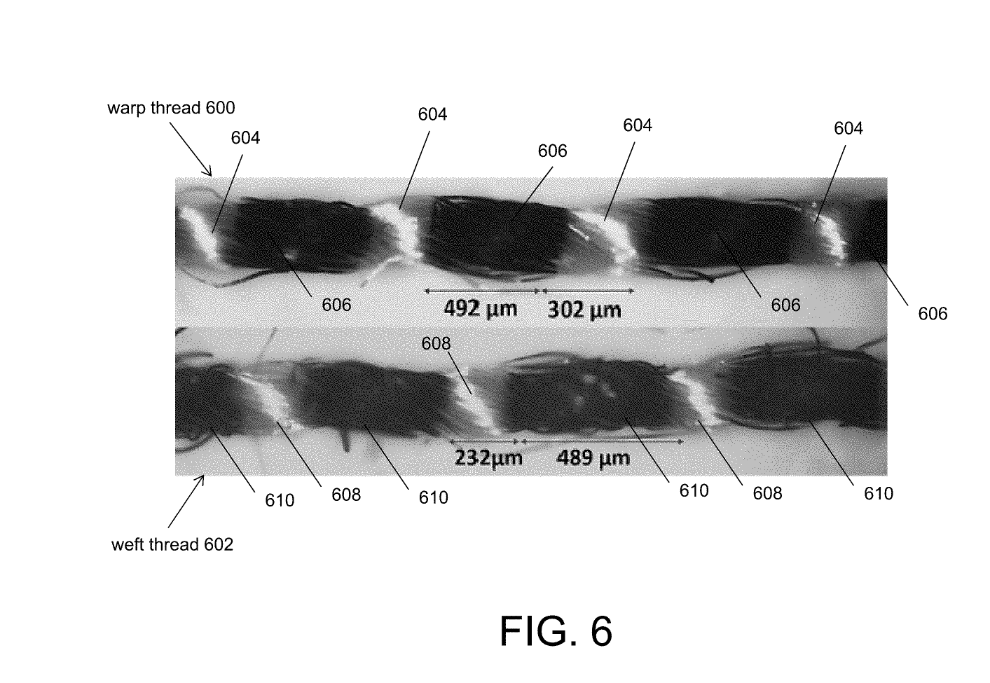

The warp threads of pre-woven textile substrates may be characterized by R₁, the ratio of the length of the exposed regions to the length of the unexposed regions. The weft threads of pre-woven textile substrates may be characterized by R₂, the ratio of the length of the exposed regions to the length of the unexposed regions. The lengths of the exposed/unexposed regions on warp and weft threads may be determined by examining the warp and weft threads of the pre-woven textile substrate after being exposed to a coating material, e.g., a conductive polymer coating. By way of illustration, FIG. 6 shows a warp thread 600 and a weft thread 602. As described in the Examples, below, each thread 600, 602 was pulled from a pre-woven textile substrate which had been previously coated with a conductive polymer coating (see FIG. 4D). As a result of the buried thread interfaces at intersections of warp and weft threads in the textile substrate, the warp thread 600 comprises a plurality of unexposed regions 604 (as evidenced by the absence of the conductive polymer coating). The warp thread 600 also comprises a plurality of exposed regions 606 (as evidenced by the presence of the conductive polymer coating). Similarly, the weft thread 602 comprises a plurality of unexposed regions 608 and exposed regions 610. FIG. 6 also indicates the length of each of the exposed/unexposed regions (which were determined as described in the Examples, below). The lengths of each of the exposed/unexposed regions can refer to an average value of a single warp/weft thread or a plurality of warp/weft threads.

Pre-woven textile substrates may further be characterized by the value of R₁×R₂. As described in the Examples, below, the inventors have found that as the value of R₁×R₂ increases, the conductivity of the conductive textile actually increases, despite the loss in surface area. Therefore, the value of R₁×R₂ of the textile substrate may be selected to achieve a selected conductivity value (e.g., a substantially maximum value) for the conductive textile. Again, the selected R₁×R₂ value will typically be a value at which the surface area of the textile substrate is not maximized. In some embodiments, the R₁×R₂ value of the pre-woven textile substrate is at least about 10. This includes embodiments in which the R₁×R₂ value is at least about 12, at least about 14, at least about 16, at least about 20, at least about 30, at least about 40, or at least about 50. This further includes embodiments in which the R₁×R₂ value is in the range of from about 10 to about 50.

For pre-knit textile substrates, the single thread or each of the multiple threads will also comprise a plurality of exposed regions and a plurality of unexposed regions. Some of the exposed regions 1010 of the upper surface 1001 of the pre-knit textile substrate 1000 are labeled in FIG. 10. Each unexposed region of the plurality of unexposed regions of the upper surface 1001 is located at each respective buried thread interface, including those formed at the intersections 1008.

The R₁, R₂, and R₁×R₂ values described above may be achieved through selection of a network type (e.g., pre-woven, pre-knit, etc.), a weave type, a stitch type, and/or thread(s) diameter for the textile substrate.

As described above, the textile substrates may also be characterized by the staple lengths of the fiber(s) from which the thread(s) are composed. As described in the Examples, below, the inventors have also found that as the staple length increases, the conductivity of the coated textile substrate increases. Therefore, the staple length of the textile substrate may also be selected to achieve a selected conductivity value (e.g., a substantially maximum value) for the conductive textile. In some embodiments, the staple length is at least 2 cm, at least 3 cm, at least 5 cm, at least 10 cm, at least 15 cm, at least 20 cm, etc. In some embodiments, the staple length is substantially the same value as the length of the thread in the textile substrate.

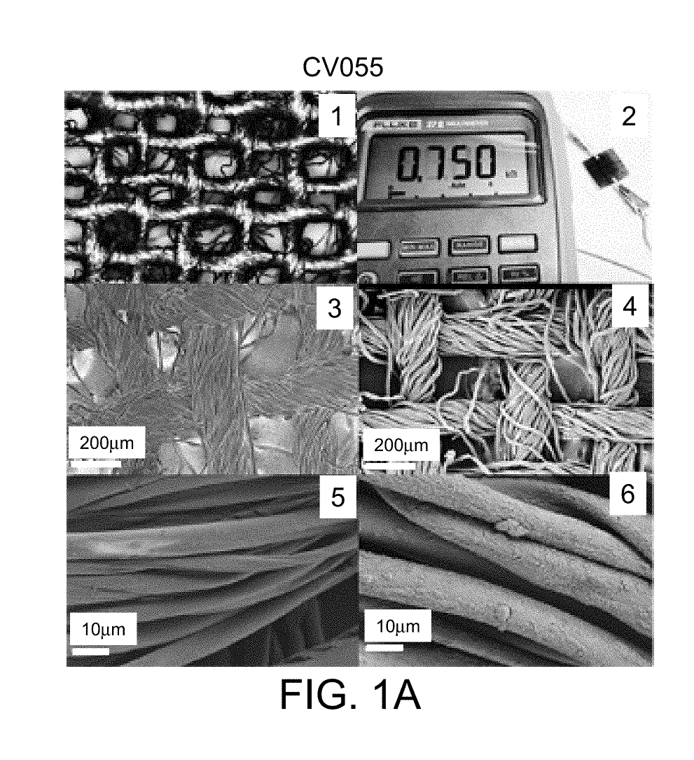

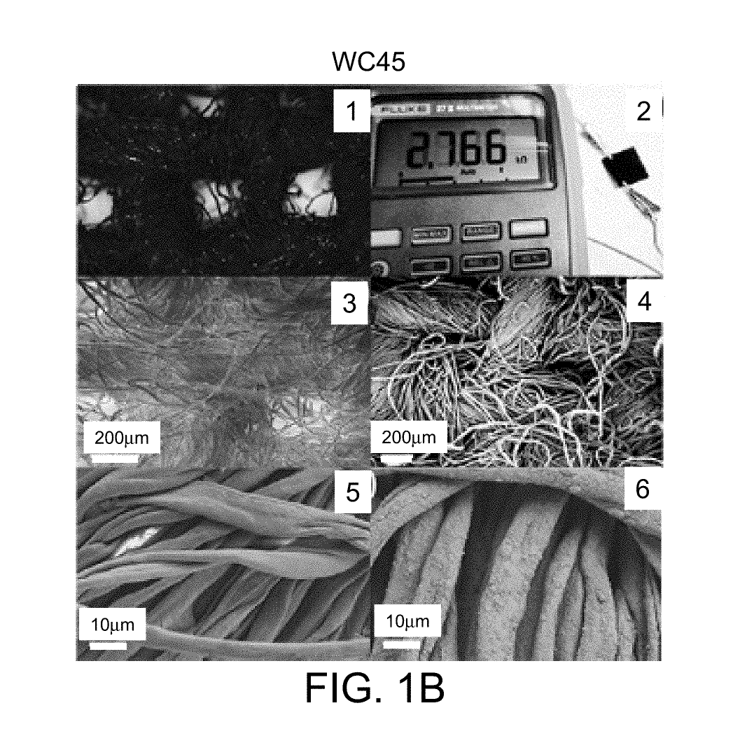

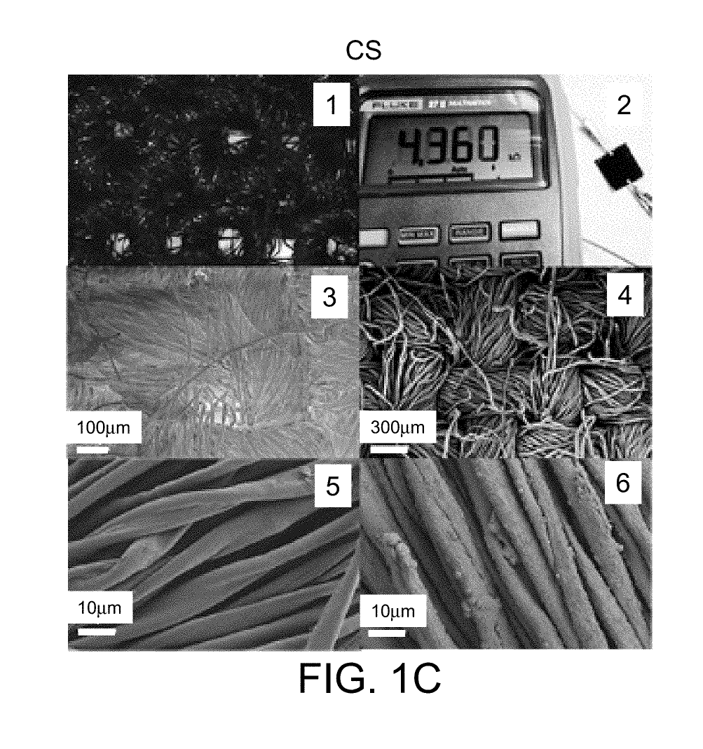

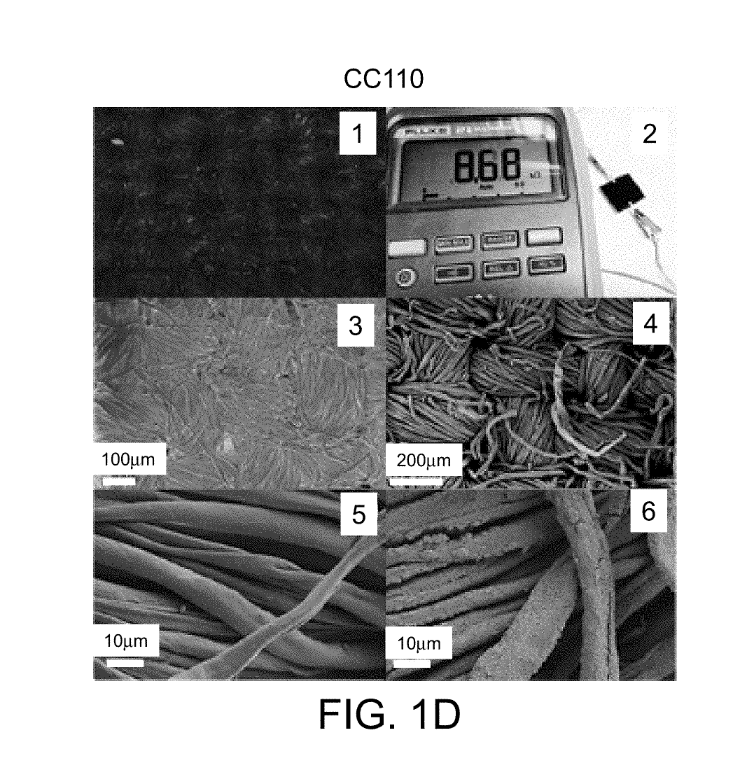

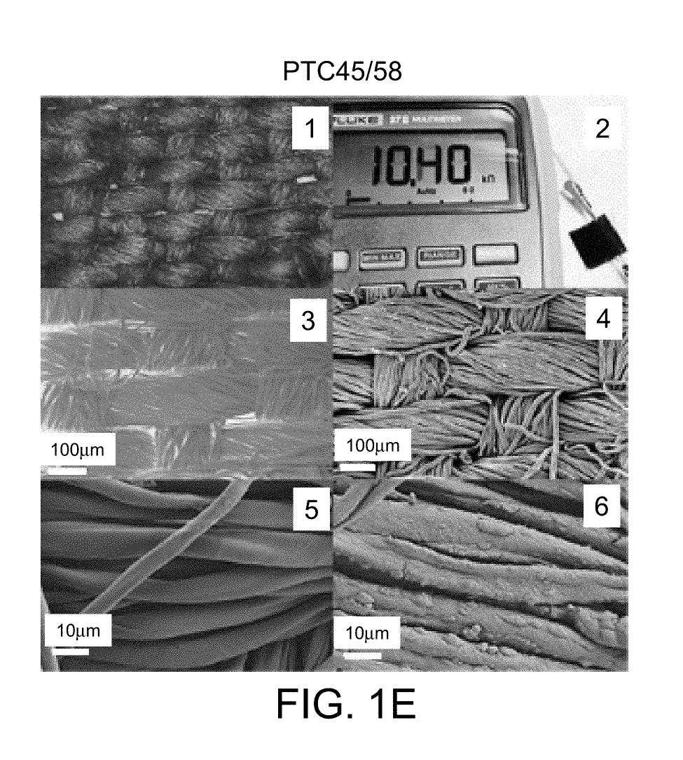

Textile substrates may also be characterized by the morphology (e.g., specific shape) of the fiber(s) from which the thread(s) are composed. By way of illustration, as described in the Examples below, the morphology of the fibers of different textile substrates differ, e.g., cotton fibers are more twisted and thus, less aligned (see FIG. 1B) as compared to straight and smooth banana fibers (see FIG. 4B). In some embodiments, the fiber(s) from which the thread(s) are composed are substantially untwisted and substantially smooth (e.g., as determined from SEM images). The term “substantially” is used in recognition of the fact that the fiber(s) may not be perfectly untwisted or perfectly smooth, but significantly less twisted and significantly smoother as compared to a reference fiber, e.g., a cotton fiber. In some embodiments, the thread(s) from which the textile substrate is composed includes a single fiber (see, e.g., FIG. 4B).

The particular conductivity value for the conductive textiles depends upon both the conductive polymer as well as the selection of textile substrate. However, the conductivity value of the conductive textile will be greater than the conductivity value of the textile substrate itself (i.e., the uncoated textile substrate). In some embodiments, the conductive textile exhibits a conductivity which is at least 8 times, at least 10 times, at least 15 times, or at least 20 times greater than the conductivity of the textile substrate itself. The comparison may be made by determining the conductivity of the coated textile substrate and uncoated textile substrate under substantially identical conditions.

A variety of conductive polymers may be used for the conductive polymer coating. The conductive polymer may be an intrinsically conductive polymer (ICP). ICPs are conjugated polymers with the charge carriers formed in the oxidation or reduction state of the polymer backbone. Illustrative suitable ICPs include polyacetylene (PA), polythiophene (PT), polypyrrole (PPy), polyaniline (PANI) and poly(3,4-ethylendioxythiophene) (PEDOT). PEDOT is particularly useful due to its intrinsic high-conductivity and environmental stability. The conductive polymer coating may be characterized by its thickness. The thickness of the conductive polymer coating may be, e.g., in the range of from about 1 nm to about 100 nm, from about 10 nm to about 100 nm, from about 25 nm to about 100 nm, or from about 50 nm to about 100 nm.

An illustrative suitable method for applying the conductive polymer coating to the surface of the textile substrates is oxidative chemical vapor deposition (oCVD). This method is useful in part because it provides a uniform, conformal coating even on highly textured surfaces. The Examples below describe illustrative suitable experimental conditions for depositing PEDOT on a variety of textile substrates using oCVD.

The conductive textiles will find use in a variety of electronic devices, i.e., those which require a conductive layer or a conductive substrate, and a variety of applications (e.g., consumer applications, military applications, etc.). An illustrative device is a solar cell comprising any of the conductive textiles as an electrode layer. In one embodiment, a solar cell comprises a conductive textile, an active layer on the conductive textile (e.g., in direct contact with) and a top electrode on the active layer (e.g., in direct contact with). The active layer, which may comprise sublayers, is a layer which is capable of converting light to electrons. The light may be light having any wavelength within the electromagnetic spectrum, including, but not limited to, the wavelengths present in solar radiation. In some embodiments, the active layer comprises a first sublayer comprising a first organic dye and a second sublayer on the first sublayer comprising a second organic dye. A variety of organic dyes may be used for the first and second sublayers, e.g., depending upon the wavelengths of light to be converted by the solar cell. Organic dyes typically used in dye sensitized solar cells may be used. A variety of conductive materials may be used for the top electrode, e.g., metals. Known thin film deposition techniques may be used to deposit the organic dye layers and top electrode. Other material layers typically used in solar cells may be included (e.g., antireflection layers, etc.). The solar cell may be used to power a variety of external devices in electrical communication with the solar cell, e.g., a cell phone, a laptop, etc.

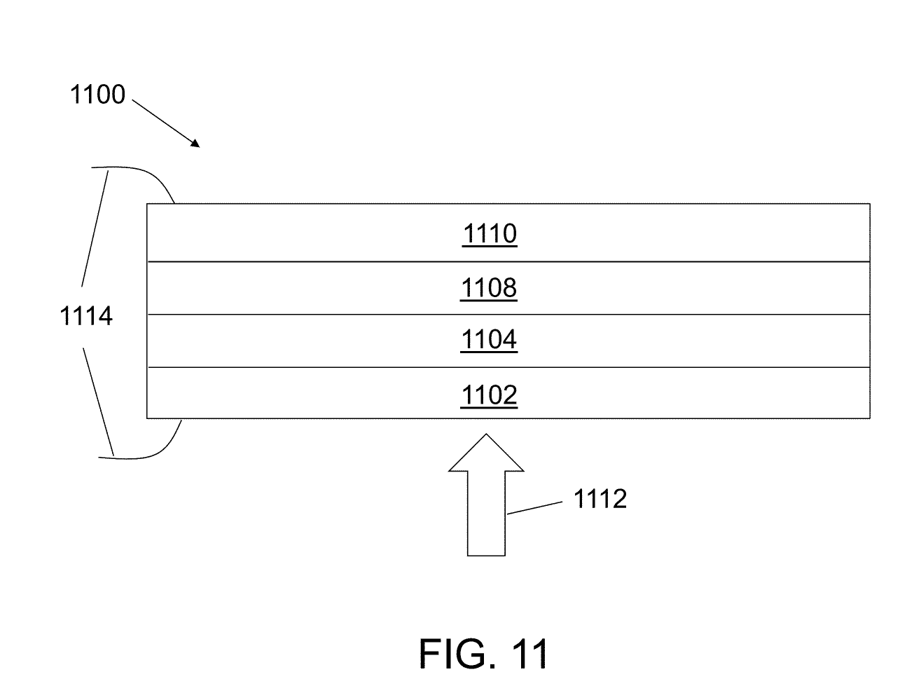

An illustrative solar cell 1100 is shown in FIG. 11. The solar cell 1100 comprises a conductive textile 1102, a first organic dye layer 1104, a second organic dye layer 1108, and a top electrode 1110. The solar cell 1100 is configured to absorb light 1112 and convert that light 1112 into free electrons which can be used to power an external device coupled to the solar cell 1100 via conductive leads 1114.

Since the conductive textiles (and devices incorporating the conductive textiles) are based on a textile substrate, the conductive textiles and related devices may be monolithically integrated into a variety of items which normally make use of textile substrates, e.g., clothing, curtains, upholstery, umbrellas, tents, etc.

### Examples

This Example relates to the relationship between electronic conductivity and textile weaving porosity and fiber morphology. The oxidative chemical vapor deposition (oCVD) technique was applied for in situ deposition of poly(3,4-ethylenedioxythiophene) (PEDOT) onto 14 plain woven textiles, spanning 7 different materials. It was found that the more porous textiles have higher conductivity in spite of the reduced surface area due to the void. The parameters R₁ and R₂ were established as the ratios between the PEDOT coated/uncoated regions on individual warp and weft threads (respectively) of the already-coated textiles. A strong correlation was found between the conductivity and R₁ and R₂. In addition to the dominating factor of porosity, a mild dependence of conductivity on the morphology of fibers in threads was found. These results support the selection of particular fabrics and/or weaving in order to achieve highly conductive textiles.

### Experimental Methods

EDOT and FeCl₃ (97%) were purchased from Aldrich and were applied as received. PEDOT deposition was carries out in a custom-built vacuum chamber. Textile substrates were rinsed with DI water and were dried by N₂ flow. Fourteen pieces of 1×1 inch different textiles were taped on 5×5 inch stage which was heated to 80° C. during deposition. The pressure of the chamber was maintained at 100 mTorr with Ar flow 1 sccm. EDOT vapor was heated to 80° C. and was introduced into the chamber at about 3 sccm controlled by a needle valve. FeCl₃ was sublimed in the chamber from a Radak furnace at 300° C. For the deposition onto the textiles, a deposition time of 5 hours was used. For deposition onto individual threads, a deposition time of 2 hours was used. The PEDOT deposited textiles and threads were dried in a vacuum oven at 70° C. under −15 mmHg for 2 hours to remove unreacted monomer. After cooling to room temperature, the textiles were rinsed with methanol to remove majority unreacted FeCl₃ and were dried by N₂ flow. For Resistance measurements, 100 nm Ag was thermally deposited on the two edges of textiles with a width of 1.5 inch for better electrical contact.

Scanning electron microscopy (SEM) images were obtained by using SEM LEO 1550. A UV-vis-NIR spectrophotometer was used to characterize the optical reflectance of PEDOT coatings on fabrics. A Thermo K-alpha x-ray photoelectron spectrometer was used for the elemental study of PEDOT films. Raman spectroscopy was performed on a DXRxi Raman imaging microscope. Microscopic images of coated textiles were taken and associated software used to measure the length of PEDOT coated and uncoated regions on the threads.

Results and Discussion

Chemical Study of PEDOT Films of Textiles

X-ray photoelectron spectroscopy (XPS) survey scan spectra of a bleached linen textile, a PEDOT film coated on linen before rinsing and after rinsing with methanol were obtained (data not shown). The three spectra are normalized to the C 1S peak. Comparing the two PEDOT film spectra, the decreased intensity of the Fe 2P peak indicates that most of unreacted FeCl₃ was removed, while some remained after rinsing. The Cl 2P and Cl 2S peaks were significantly decreased with rinsing due to the removed FeCl₃. Another possible loss of Cl is from the form of PEDOT⁺Cl⁻, where Cl⁻ serves as a dopant. Part of PEDOT⁺ was reduced to the neutralized form PEDOT⁰ with methanol rinsing. However, the reduction process cannot be proven by the XPS survey scan alone. The S 2p and S 2S peaks are greatly enhanced after rinsing.

Absorption spectra of the same PEDOT films as measured via XPS were also obtained (data not shown). The absorption spectra were obtained by transformation of 1-reflectance, in which the reflectance is measured. The PEDOT coated linen before rinsing and after rinsing showed an evolution of absorption in the visible region and a continuously high absorption in the near infrared (NIR) region, corresponding to the electronic transition of states in the band gap of doped PEDOT (PEDOT⁺). After rinsing, the spectrum showed a slight increase in the 500-600 nm region and a decrease in the region above 600 nm. This shift reveals some PEDOT⁺ is reduced to PEDOT⁰ by methanol rinsing, which induces the decreased in-gap states.

Raman spectra of the PEDOT coated linen before rinsing and after rinsing were also obtained (data not shown). The Raman spectra further revealed the presence of PEDOT⁰ after rinsing. Peaks at 1261 cm⁻¹ and 1365 cm⁻¹, which were attributed to the C_{α}=C_{α′} inter-ring stretching and C_{β}-C_{β} stretching, respectively, do not shift upon reduction by rinsing. The peak at 1427 cm⁻¹ in the sample after rinsing corresponds to the C_{α}=C_{β} stretching of neutralized PEDOT⁰. Before rinsing, the C_{α}=C_{β} stretching resonance peak is right shifted and broadened, corresponding to the doped PEDOT⁺. The presence of PEDOT⁰ after rinsing is also reflected by the right shifted peak at 1508 cm⁻¹ and left shifted peak at 1550 cm⁻¹ compared to PEDOT⁺.

The XPS, absorption and Raman spectra reveal the formation of PEDOT on textile by oCVD and the reducing effect of rinsing by methanol.

Textile Porosity and Fiber Morphology Effect on Conductivity

The correlation between the porosity and the conductivity of plain woven textiles was studied. Seven fiber materials were chosen including the cotton, linen, silk, wool, bamboo rayon, pineapple fiber and banana fiber materials as shown in FIGS. 1A-1E, 2A-2C, 3A-3B, and 4A-4D. In these figures, panel 1 shows the microscopic image of the PEDOT coated textile; panel (2) shows the resistance measurement of the 1×1 inch² textile; panels (3) and (5) show the SEM images of the pristine textile (at different magnifications); and panels (4) and (6) show the SEM images of the PEDOT coated textile (at different magnifications). The porosity of the textiles is evident by the microscopic and the SEM images.

FIGS. 1A-1E show five cotton textiles having different porosities: CV055 (FIG. 1A), WC45 (FIG. 1B), CS (FIG. 1C), CC110 (FIG. 1D) and PTC45/58 (FIG. 1E), shown in the reverse order of porosity. The results show that within these five cotton textiles, the more porous textiles have the lower resistance or the higher conductivity. The resistance of 1×1 inch² textiles is 0.75 kΩ for CV055, 2.77 kΩ for WC45, 4.36 kΩ for CS, 8.68 kΩ for CC110, and 10.4 kΩ for PTC45/58. The SEM images of panels (5) and (6) show the individual fibers in a single thread before and after PEDOT coating, revealing the similar morphologies of cotton fibers in the five different textiles. PEDOT films form conformal and continuous coating on the top layer of fibers in threads, and on the exposed regions of the inner layers of fibers in threads.

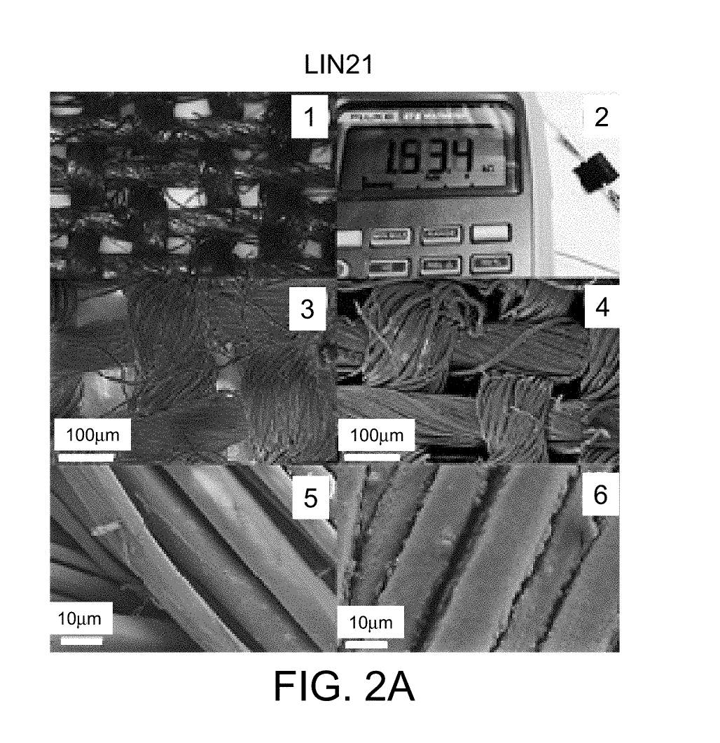

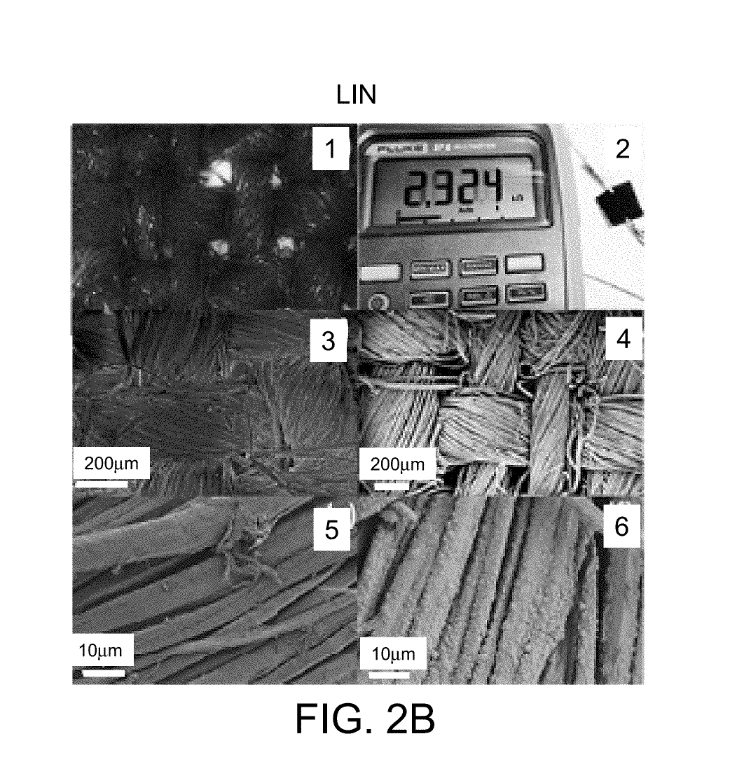

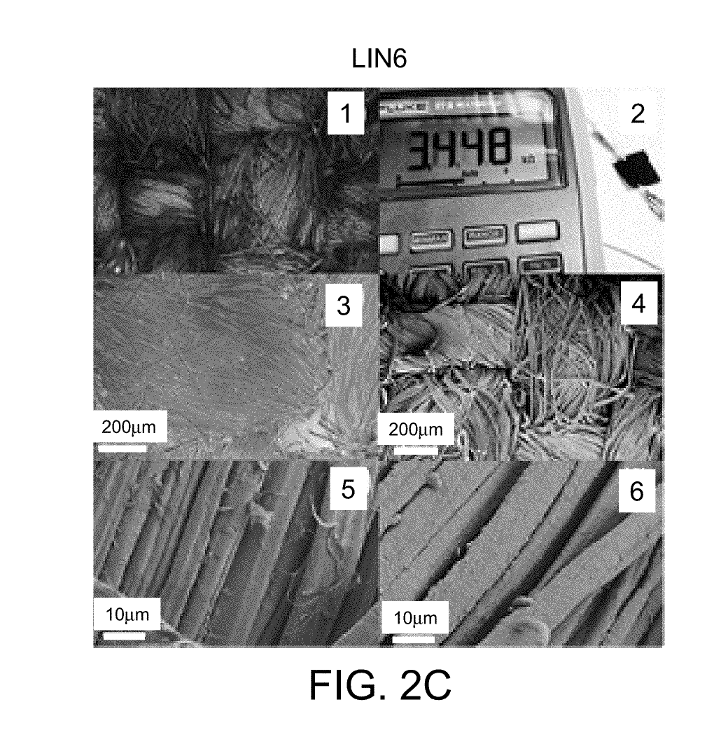

FIGS. 2A-2C show three linen textiles having different porosities: LIN21 (FIG. 2A), LIN (FIG. 2B) and LIN6 (FIG. 2C). Again, the more porous linen textiles exhibit the higher conductivity. The resistance is 1.53 kΩ for LIN21, 2.32 kΩ for LIN and 3.45 kΩ for LIN6. As shown in SEM images of panel (5), linen fibers are more ordered and more tightly aligned than the cotton fibers. The surface roughness of fibers in these three specific linen textiles has some differences. LIN21 fibers have the smoothest surface, followed by LIN6 fibers, and LIN fibers have the roughest surface. The SEM images of panel (6) indicate highly conformal coating of PEDOT. The morphology of PEDOT film largely depends on the fiber surface roughness.

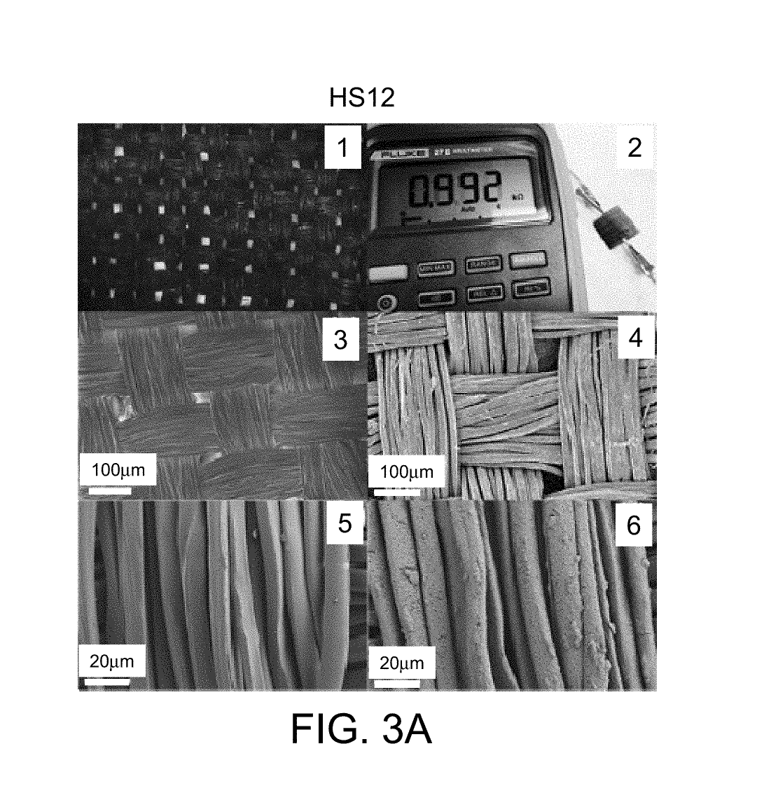

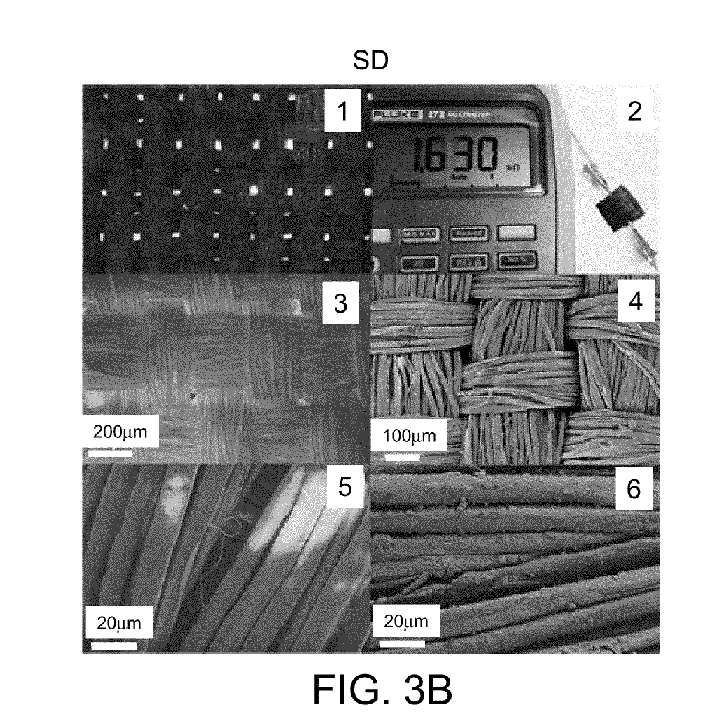

FIGS. 3A-3B show two silk textiles, HS12 (FIG. 3A) and SD (FIG. 3B). Both samples are composed of straightly-aligned, non-twisted silk fibers as shown in panels (5) and (6). HS12 has slightly higher porosity than SD, and higher conductivity with PEDOT coating. The resistance of 1×1 inch² textiles is 0.99 kΩ for HS12, and 1.63 kΩ for SD.

FIGS. 4A-4D show four other textiles, including the highly porous textiles of pineapple fiber (FIG. 4A), banana fiber (FIG. 4B), wool gauze (FIG. 4C), and a dense woven textile of bamboo rayon (FIG. 4D). The pineapple fiber and banana fiber share some common characteristics which differ from other fiber materials. Both fibers are rigid, straight and non-twisted. Each thread is composed of a single fiber as shown in panels (5) and (6) of FIGS. 4A and 4B. The resistance is 305.2Ω for pineapple fiber fabric and 328.6Ω for banana fiber fabric respectively. The wool gauge is a highly porous textile with twisted fibers. The resistance of the wool gauge is 2.62 kΩ. Bamboo rayon has slightly twisted fibers, forming medium porous textile compared to other samples. The resistance of bamboo rayon textile is 9.46 kΩ.

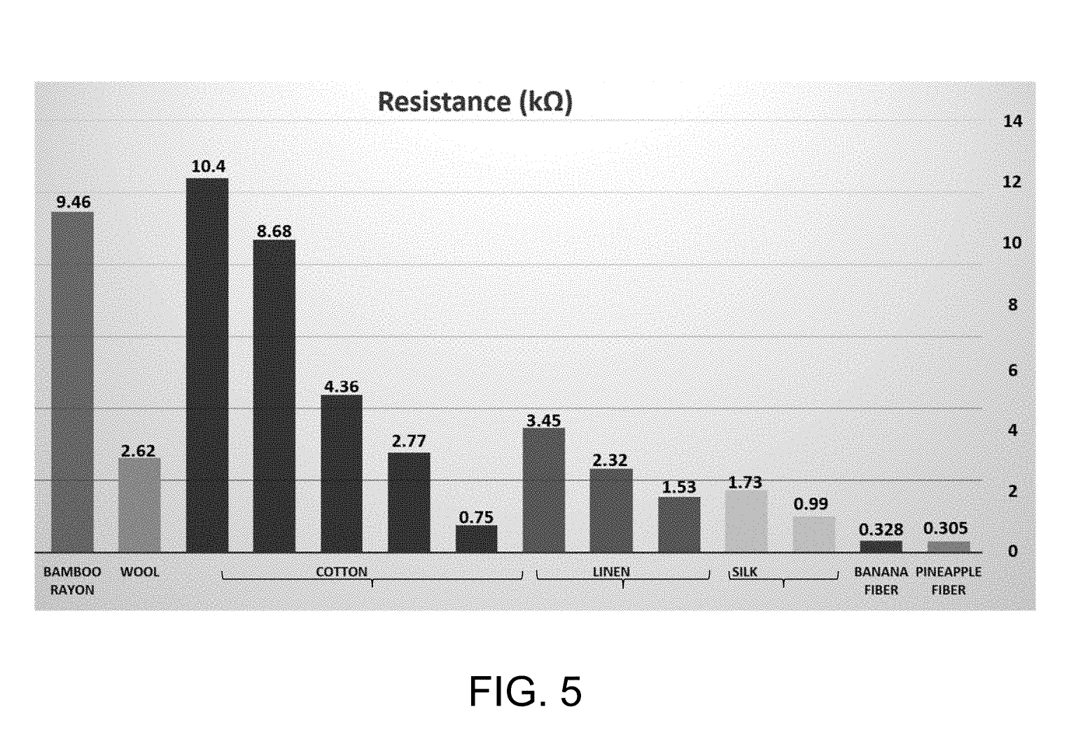

FIG. 5 summarizes the resistance of all samples. Table 1 lists the sample code, textile density and resistance. For most samples, density is inversely proportional to porosity (e.g., the linen and silk textiles studied in this Example). Exceptions were observed with the cotton textiles, in which WC45 and CS have higher porosity than CC110 and PTC45/58, but higher density. This is because the threads size of WC45 and CS is larger than that of CC110 and PTC45/58. It can be concluded that for the same material textiles, if the threads size are same, the density can be a parameter to quantify the porosity and can also be correlated to conductivity.

TABLE 1
Summary of textile sample code, density and resistance of
the deposited PEDOT films measured on 1 × 1 inch² samples.

| | | Density | Resistance |
|---|---|---|---|
| Fabric Category | Fabric Code (specification) | (Oz/yd²) | (kΩ) |
| Cotton | CV055 (Cotton Voile) | 1.9 | 0.75 |
| | WC45 (Waterford Cotton) | 4.5 | 2.77 |
| | CS (Cotton Sheeting) | 4.2 | 4.36 |
| | CC110 (Combed Cotton) | 3.3 | 8.68 |
| | PTC45/58 (Pimatex Cotton) | 3.7 | 10.40 |
| Linen | LIN21 | 3.8 | 1.53 |
| | LIN | 4.7 | 2.32 |
| | LIN6 | 8 | 3.45 |
| Silk | HS12 (Silk Habotai 12 mm) | 1.5 | 0.99 |
| | SD (Silk Dupion 19 mm) | 2.375 | 1.63 |
| Wool Gauze | PWFA | 3.6 | 2.62 |
| Bamboo Rayon | BBF | 3.2 | 9.46 |
| Pineapple Fiber | PINA-3001 | 0.77 | 0.305 |
| Banana Fiber | ABCA-3001 | 1.4 | 0.328 |

Although more porous textiles have less surface area for the PEDOT coating (due to voids defined by the threads/fibers), it was observed that the more porous textiles actually exhibit higher conductivity. The individual threads pulled out of the textile after PEDOT coating were further investigated. Microscope images of threads from all PEDOT coated textiles were obtained. FIG. 6 shows an illustrative image of PEDOT coated bamboo rayon. The top image shows a warp thread and the bottom image shows a weft thread. Darker regions indicate the presence of the PEDOT coating; lighter regions indicate the absence of the PEDOT coating. The uncoated regions originate from the overlap of warp and weft threads at intersections. As shown in FIG. 6, the length of the coated regions and the uncoated regions for both warp and weft threads and for each textile were measured using the software described in the “Experimental Methods” section above. The parameter R₁=(length of coated region)/(length of uncoated region) for a warp thread. The parameter R₂=(length of coated region)/(length of uncoated region) for a weft thread. These values, as well as the value of (R₁×R₂), are summarized in Table 2. Without wishing to be bound by any particular theory, it is believed that due to the presence of the uncoated regions, electron transport cannot be continuous along a single thread. Instead, at each intersection, electrons have to change their direction to other conducting channels to continue transport, which reduces mobility. R₁ and R₂ values can be considered to be parameters quantifying the probability for an electron to continuously travel along a single thread before it changes direction. The product value R₁×R₂ is the same probability in two dimensions. As shown in Table 2, within each fabric category, textiles with larger R₁×R₂ values exhibit lower resistances (greater conductivities).

TABLE 2
Summary of the length ratio of coated regions/uncoated regions
for warp and weft threads taken from PEDOT coated textiles.
Also shown is the product of the length ratios and the resistance of
the PEDOT coating measured on 1 × 1 inch² samples.

| Fabric | Fabric | Length Ratio of | Product of | Resistance |
|---|---|---|---|---|
| Category | Code | PEDOT/no PEDOT | R₁ and R₂ | (kΩ) |
| Cotton | CV055 | R₁ = 2.9 | R₁ × R₂ = 17.1 | 0.75 |
| | | R₂ = 5.9 | | |
| | WC45 | R₁ = 2.7 | R₁ × R₂ = 10.3 | 2.77 |
| | | R₂ = 3.8 | | |
| | CS | R₁ = 2.1 | R₁ × R₂ = 4.4 | 4.36 |
| | | R₂ = 2.1 | | |
| | CC110 | R₁ = 2.4 | R₁ × R₂ = 3.4 | 8.68 |
| | | R₂ = 1.4 | | |
| | PTC45/58 | R₁ = 2.6 | R₁ × R₂ = 3.1 | 10.40 |
| | | R₂ = 1.2 | | |
| Linen | LIN21 | R₁ = 2.2 | R₁ × R₂ = 12.1 | 1.53 |
| | | R₂ = 5.5 | | |
| | LIN | R₁ = 2.0 | R₁ × R₂ = 2.8 | 2.32 |
| | | R₂ = 1.4 | | |
| | LIN6 | R₁ = 1.2 | R₁ × R₂ = 1.2 | 3.45 |
| | | R₂ = 1.0 | | |
| Silk | HS12 | R₁ = 4.0 | R₁ × R₂ = 14.4 | 0.99 |
| | | R₂ = 3.6 | | |
| | SD | R₁ = 1.6 | R₁ × R₂ = 4.0 | 1.63 |
| | | R₂ = 2.5 | | |
| Wool | PWFA | R₁ = 4.1 | R₁ × R₂ = 17.6 | 2.62 |
| Gauze | | R₂ = 4.3 | | |
| Bamboo | BBF | R₁ = 1.6 | R₁ × R₂ = 3.4 | 9.46 |
| Rayon | | R₂ = 2.1 | | |
| Pineapple | PINA- | R₁ = 4.0 | R₁ × R₂ = 14.0 | 0.305 |
| Fiber | 3001 | R₂ = 3.5 | | |
| Banana | ABCA- | R₁ = 4.8 | R₁ × R₂ = 43 2 | 0.328 |
| Fiber | 3001 | R₂ = 9.0 | | |

Without wishing to be bound to any particular theory, it is believed that the porosity of textiles has two opposite effects on the conductivity. On one hand, the porosity reduces the surface area for PEDOT coating, which reduces conductivity. On the other hand, porosity increases R₁ and R₂ values, which increases conductivity. If the surface area factor dominates, the conductivity should decrease with increasing porosity. If the R₁ and R₂ factor dominates, the conductivity should increase with increasing porosity. Since it was observed that the more porous textiles within each category have lower resistances (higher conductivities), it is believed that the R₁ and R₂ factor dominates.

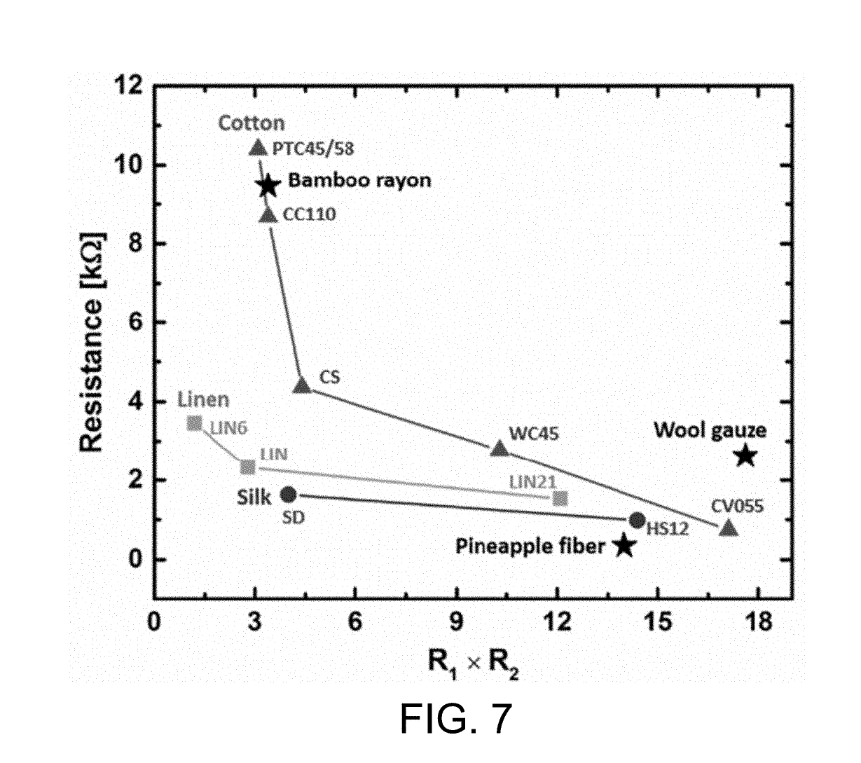

FIG. 7 plots resistance versus R₁×R₂ for each textile. The plot of the cotton textiles displays two regions. The first region includes the porous textiles of cotton CV055, WC45 and CS, in which the resistance increases with R₁×R₂ more slowly (i.e., has a smaller slope). The second region includes the dense textiles of cotton CC110 and PTC45/58, in which the resistance increases with R₁×R₂ more quickly (i.e., has a larger slope). Without wishing to be bound to any particular theory, it is believed that the reduced porosity when moving from CV055, WC45 to CS increases surface area for PEDOT coating which suppresses the loss of conductivity (rise in resistance) due to the reduced R₁×R₂. In the second region of dense textiles, the surface area is the same for both CC110 and PTC45/58. Thus, for these textiles, R₁×R₂ value is the only factor determining the conductivity. As shown in FIG. 7, conductivity decreases (resistance increases) dramatically as R₁×R₂ decreases.

The three linen and two silk samples also follow the trend that the smaller R₁×R₂ value results in lower conductivity. Comparing different materials, cotton has relatively lower conductivity, followed by linen and silk. Pineapple fiber fabric has the highest conductivity. Bamboo rayon falls in the trend line of cotton, and wool gauze has slightly lower conductivity compared with cotton CV055 which has a similar R₁×R₂ value. The banana fiber textile was not included in the graph due to its large R₁×R₂ value.

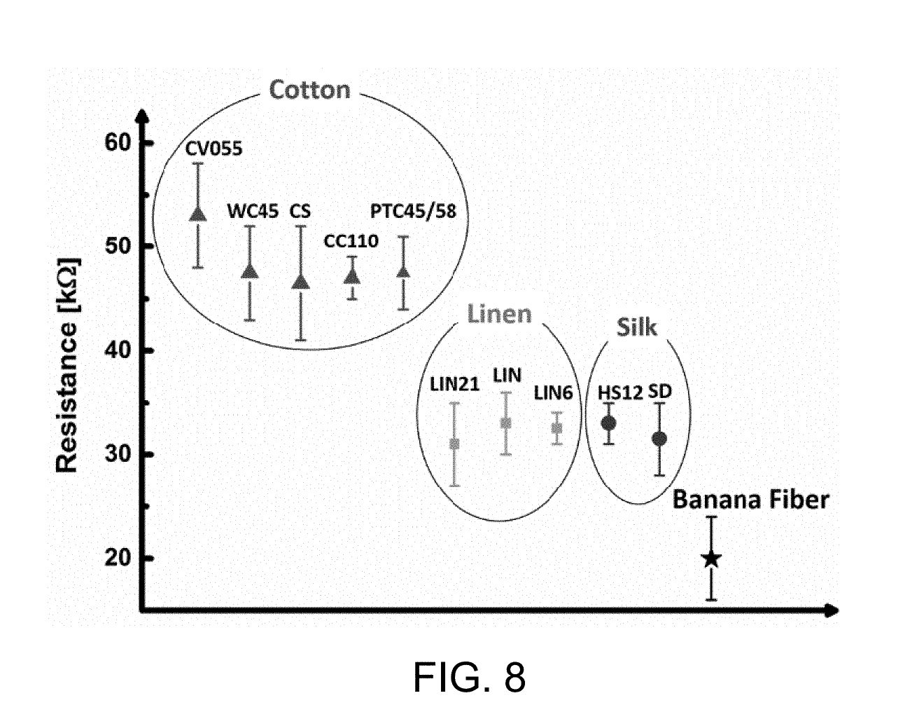

The conductivity of single threads fully deposited with PEDOT was investigated. FIG. 8 summarizes the conductivity of threads pulled out of textiles before doing deposition. The textiles investigated include cotton, linen, silk and banana fiber. All threads were three inches long. The error bars are based on the measurements of five threads. As shown in FIG. 8, all cotton threads have similar resistances, and slightly higher than the threads of the other materials. Linen and silk threads have similar conductivities. Banana fiber thread has the lowest resistance (highest conductivity). This comparison is similar to the conductivity of coated textiles summarized in FIG. 7, which suggests the individual fiber type is another factor mildly affecting the conductivity of PEDOT coated textiles. The different conductivities of single threads may be attributed to the morphology of the fibers. As shown in SEM images in panels (5) and (6) of cotton (FIGS. 1A-1E), linen (FIGS. 2A-2C), silk (FIGS. 3A-3B) and banana fiber (FIG. 4B), cotton fibers are less ordered and twisted, which affect the ability to achieve a continuous coating of PEDOT on a fiber, since some regions of a fiber will be facing away from the top, exposed surface. Linen and silk fibers have a similar morphology, which is straight and well aligned. Banana fiber thread contains only a single fiber, facilitating PEDOT coating and electron transport.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more”.

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. A conductive textile comprising a textile substrate comprising a network of one or more threads, each thread comprising one or more fibers, the one or more threads arranged to define a plurality of pores and a plurality of intersections distributed throughout the textile substrate, and a conductive polymer coating on a surface of the textile substrate, wherein the textile substrate is characterized by a porosity which is sufficiently high to achieve a substantially maximum conductivity for the conductive textile.

2. The conductive textile of claim 1, wherein the textile substrate is substantially non-conductive.

3. The conductive textile of claim 2, wherein the textile substrate is substantially free of metal.

4. The conductive textile of claim 1, wherein the porosity is at least about 20%.

5. The conductive textile of claim 1, wherein the textile substrate is characterized by a density which is sufficiently low to achieve the substantially maximum conductivity for the conductive textile, further wherein the density is no more than about 4 oz/yd².

6. The conductive textile of claim 1, wherein the textile substrate is a pre-woven textile substrate comprising a first plurality of threads interlaced with a second plurality of threads, wherein the threads of the first plurality of threads are oriented approximately perpendicular to the threads of the second plurality of threads.

7. The conductive textile of claim 1, wherein the textile substrate is a pre-knit textile substrate comprising one or more threads interlooped to create rows and columns of vertically and horizontally interconnected stitches distributed throughout the textile substrate.

8. The conductive textile of claim 6, wherein the textile substrate is characterized by a R₁×R₂ value which is selected to achieve the substantially maximum conductivity.

9. The conductive textile of claim 8, wherein the R₁×R₂ value is at least about 12.

10. The conductive textile of claim 1, wherein the one or more fibers are substantially untwisted and substantially smooth along their lengths.

11. The conductive textile of claim 1, wherein each thread comprises a single fiber.

12. The conductive textile of claim 1, wherein the substantially maximum conductivity is at least 10 times greater than the conductivity of the textile substrate as measured under the same conditions.

13. The conductive textile of claim 1, wherein the conductive polymer coating comprises an intrinsically conductive polymer.

14. The conductive textile of claim 13, wherein the intrinsically conductive polymer is poly(3,4-ethylenedioxythiophene).

15. The conductive textile of claim 1, wherein the textile substrate is selected from protein-based, animal materials and cellulose-acetate-based, plant materials.

16. An electronic device comprising the conductive textile of claim 1 as an electrode.

17. The electronic device of claim 16, wherein the conductive textile is monolithically integrated into a textile component of an umbrella or automotive upholstery.

18. A solar cell comprising:
(a) a conductive textile comprising a textile substrate comprising a network of one or more threads, each thread comprising one or more fibers, the one or more threads arranged to define a plurality of pores and a plurality of intersections distributed throughout the textile substrate, and a conductive polymer coating on a surface of the textile substrate, wherein the textile substrate is characterized by a porosity which is sufficiently high to achieve a substantially maximum conductivity for the conductive textile;
(b) an active layer on the conductive textile; and
(c) a top electrode on the active layer.

19. The solar cell of claim 18, wherein the active layer comprises a first sublayer comprising a first organic dye and a second sublayer on the first sublayer comprising a second organic dye.

20. The solar cell of claim 18, wherein the textile substrate is a pre-woven textile substrate comprising a first plurality of threads interlaced with a second plurality of threads, wherein the threads of the first plurality of threads are oriented approximately perpendicular to the threads of the second plurality of threads.
